(19) United States
(12) Patent Application Publication
(10) Pub. No.: US 2018/0115496 A1
(43) Pub. Date: Apr. 26, 2018

(54) MECHANISMS TO IMPROVE DATA LOCALITY FOR DISTRIBUTED GPUS

(71) Applicant: Advanced Micro Devices, Inc., Sunnyvale, CA (US)

(72) Inventors: Yasuko Eckert, Redmond, WA (US); Onur Kayiran, Sunnyvale, CA (US); Nuwan S. Jayasena, Sunnyvale, CA (US); Gabriel H. Loh, Bellevue, WA (US); Dong Ping Zhang, San Jose, CA (US)

(21) Appl. No.: 15/331,002

(22) Filed: Oct. 21, 2016

(51) Int. Cl. H04L 12/911; H04L 12/863

(52) U.S. Cl. CPC H04L 47/70; H04L 67/10; H04L 47/50

(57) ABSTRACT

Systems, apparatuses, and methods for implementing mechanisms to improve data locality for distributed processing units are disclosed. A system includes a plurality of distributed processing units (e.g., GPUs) and memory devices. Each processing unit is coupled to one or more local memory devices. The system determines how to partition a workload into a plurality of workgroups based on maximizing data locality and data sharing. The system determines which subset of the plurality of workgroups to dispatch to each processing unit of the plurality of processing units based on maximizing local memory accesses and minimizing remote memory accesses. The system also determines how to partition data buffer(s) based on data sharing patterns of the workgroups. The system maps to each processing unit a separate portion of the data buffer(s) so as to maximize local memory accesses and minimize remote memory accesses.

### BACKGROUND

### Description of the Related Art

Multiple distributed processing units (e.g., graphics processing units (GPUs) can be utilized to execute a software application in parallel. For example, a large GPU can be implemented by linking together multiple smaller GPU chips. In a system in which each GPU chip has an associated local memory device, the latency, bandwidth, and energy of memory accesses differ depending on whether an access is to a local or remote memory device. While implementing a large GPU with multiple smaller GPU chips helps reduce the manufacturing cost due to the improved yield of the smaller dies, running existing software applications on distributed processing units can result in increased memory access latencies due to frequent remote memory accesses.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one embodiment of a computing system.

FIG. 2 is a block diagram of another embodiment of a computing system.

FIG. 3 is a block diagram of one embodiment of a command processor.

FIG. 4 illustrates diagrams of one embodiment of data buffer and workgroup partitioning.

FIG. 5 illustrates diagrams of another embodiment of data buffer and workgroup partitioning.

FIG. 6 is a generalized flow diagram illustrating one embodiment of a method for partitioning a workload and data buffers.

FIG. 7 is a generalized flow diagram illustrating another embodiment of a method for partitioning a workload and data buffers.

FIG. 8 is a generalized flow diagram illustrating one embodiment of a method for partitioning a workload into subsets of workgroups that share a threshold amount of data.

### DETAILED DESCRIPTION OF EMBODIMENTS

In the following description, numerous specific details are set forth to provide a thorough understanding of the methods and mechanisms presented herein. However, one having ordinary skill in the art should recognize that the various embodiments may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Various systems, apparatuses, methods, and computer-readable mediums for partitioning workgroups and data for dispatch to a plurality of distributed processing units are disclosed. In one embodiment, a system is configured to determine how to partition a workload into a plurality of workgroups based on maximizing data locality and data sharing. In one embodiment, the system includes a plurality of distributed processing units and a plurality of memory devices. In one embodiment, each processing unit of the plurality of processing units is coupled to one or more local memory devices of the plurality of memory devices. In one embodiment, the distributed processing units are graphical processing units (GPUs). In another embodiment, the distributed processing units are processing-in-memory (PIM) devices. In other embodiments, the distributed processing units can be any of various other types of processors or computing devices.

In one embodiment, the system is configured to determine which subset of the plurality of workgroups to dispatch to each processing unit of the plurality of processing units based on maximizing local memory accesses and minimizing remote memory accesses. The system is also configured to determine how to partition data buffer(s) based on the data sharing patterns and data access patterns of the workgroups. Then, the system maps to each processing unit a separate partition of the data buffer(s) so as to maximize local memory accesses and minimize remote memory accesses.

In one embodiment, the system is configured to partition a workload into a plurality of workgroups based on a dimensionality of the workload. The system can then dispatch N consecutive workgroups to a given processing unit, wherein N is a positive integer. In one embodiment, the size of N can be determined by dividing the total number of workgroups in the workload or computation kernel by the number of processing units in the system. The system can also partition one or more buffers along the same dimensionality as the workload.

In another embodiment, the system is configured to dispatch workgroups that share a threshold amount of data to the same processing unit. The system can also dispatch workgroups that access different datasets to the same processing unit if these different datasets are located within the same data partitions, even if these workgroups do not actually share data or share a threshold amount of data. In this embodiment, the system analyzes the data sharing patterns, data access patterns, and/or data locality patterns of the plurality of workgroups. Depending on the embodiment, the data sharing patterns, data access patterns, and/or data locality patterns can be determined at run-time, at compile-time, or via profiling prior to the execution of the workload. After analyzing the various patterns, the system can determine which workgroups share a threshold amount of data and/or access the same data partitions. Then, the system can dispatch workgroups that share a threshold amount of data and/or access the same data partitions to the same processing unit.

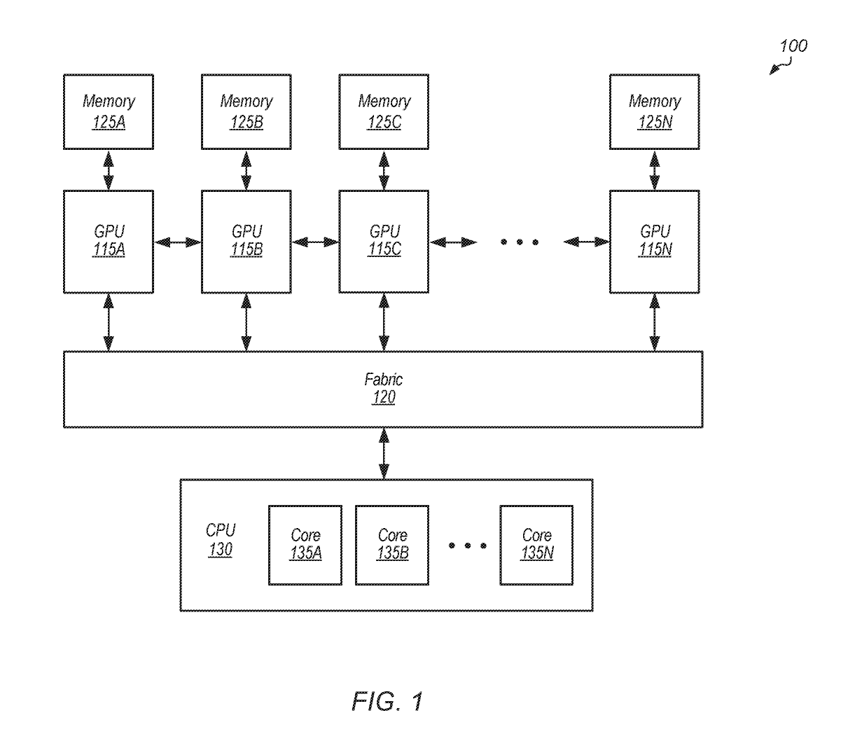

Referring now to FIG. 1, a block diagram of one embodiment of a computing system 100 is shown. Computing system 100 includes graphics processing units (GPUs) 115A-N, memories 125A-N, fabric 120, and CPU 130. Computing system 100 can also include other components which are not shown in FIG. 1 to avoid obscuring the figure. GPUs 115A-N are representative of any number and type of processing units (e.g., CPUs, field programmable gate arrays (FPGAs), application specific integrated circuits (ASICs), digital signal processors (DSPs), specific circuits, accelerators). Each GPU 115A-N is coupled to a corresponding local memory 125A-N. The GPUs 115A-N can be connected together using any of various types of interconnect, bus, or network technologies (e.g., peripheral component interconnect (PCI) bus, PCI-Extended (PCI-X) bus, PCIE (PCI Express) bus). In one embodiment, the plurality of GPUs 115A-N can be managed as a unified processor. Although not explicitly shown in FIG. 1, system 100 can also include one or more cache memories that are internal to the GPUs 115A-N and cores 135A-N.

Each memory 125A-N is representative of any number and type of memory devices. In one embodiment, each memory 125A-N is a random access memory (RAM) for use with a corresponding GPU 115A-N. The RAM implemented can be static RAM (SRAM), dynamic RAM (DRAM), Resistive RAM (ReRAM), Phase Change RAM (PCRAM), or any other volatile or non-volatile RAM. The type of DRAM that can be used to implement each memory 125A-N includes (but is not limited to) double data rate (DDR) DRAM, DDR2 DRAM, DDR3 DRAM, and so forth. Other types of memories 125A-N can also be utilized in system 100, including high-density DRAM, eDRAM, 3D stacked memory (e.g., stacked DRAM), interposer-based integrated memory, multi-chip modules (MCM), magneto-optical storage medium, read only memory (ROM), synchronous DRAM (SDRAM), double data rate SDRAM (DDR SDRAM), phase-change memory, spin-transfer torque magnetic RAM, memristor, extended data output (EDO) RAM, Rambus RAM, Rambus DRAM, erasable programmable memory (EEPROM), solid-state memory, hard disk drive, optical storage mediums, etc. For workgroups executing on the GPUs 115A-N, memory requests that access the tightly coupled local memory can be performed with lower latency and lower power consumption than memory requests that access remote memory. Remote memory for a given GPU 115A-N is defined as a memory device that is coupled to one of the other GPUs 115A-N.

Fabric 120 can be any type of communication fabric or interconnect, depending on the embodiment. For example, fabric 120 can be a bridge, northbridge, southbridge, backplane, or the like. CPU 130 includes cores 135A-N, which are representative of any number and type of processor cores. CPU 130 can also be referred to as the host of system 100. In other embodiments, system 100 can include more than one CPU and thus more than one host. The cores 135A-N of CPU 130 are configured to execute the main control software of system 100, such as an operating system. Generally, software executed by CPU 130 during use can control the other components of system 100 to realize the desired functionality of system 100. CPU 130 can also execute other software, such as application programs. The application programs can provide user functionality, and can rely on the operating system for lower level device control. In one embodiment, software executing on CPU 130 is configured to dispatch workgroups to GPUs 115A-N. Additionally, software executing on CPU 130 is configured to partition data buffers and map the partitions to GPUs 115A-N to maximize local memory accesses and minimize remote memory accesses by the workgroups executing on GPUs 115A-N.

In one embodiment, software executing on CPU 130 is configured to control the dispatch of workgroups across multiple distributed GPUs 115A-N. In another embodiment, software executing on one or more other processors (e.g., GPUs 115A-N) is configured to control the dispatch of workgroups across multiple distributed GPUs 115A-N. In a further embodiment, hardware (e.g., field programmable gate array (FPGA), application specific integrated circuit (ASIC)) is configured to control the dispatch of workgroups across multiple distributed GPUs 115A-N. In other embodiments, any suitable combination of hardware and/or software is configured to control the dispatch of workgroups across multiple distributed GPUs 115A-N.

In one embodiment, the software and/or hardware of system 100 is configured to partition a workload into a plurality of workgroups based on a dimensionality of the workload. For example, for a two-dimensional workload (i.e., a workload based on a two-dimensional domain or data set), the workload can be partitioned into workgroups along one dimension of the workload while keeping the other dimension fixed. Accordingly, for a two-dimensional workload, the workload can be partitioned into sets of workgroups from the same column, or the workload can be partitioned into sets of workgroups from the same row. For a three-dimensional workload (i.e., a workload based on a three-dimensional domain or data set), the workload can be partitioned into sets of workgroups along one dimension of the workload while keeping the other two dimensions fixed. The data buffers consumed by the workload can also be partitioned along the same dimensionality as the workload.

As used herein, the term “kernel” can be defined as a function declared in a program. A “kernel” can be executed concurrently on multiple processing elements. As used herein, the term “workload” is defined as the total amount of work being performed to execute a section of code including one or more functions operating on n-dimensional input data. As used herein, the term “work-item” is defined as one of a collection of parallel executions of a kernel invoked on a processing unit by a command. A work-item can be executed by one or more processing elements as part of a workgroup executing on a processing unit. As used herein, the term “workgroup” is defined as a collection of related work-items that execute on a single processing unit.

System 100 can correspond to any of various types of computer systems or computing devices, including, but not limited to, a personal computer system, desktop computer, laptop or notebook computer, supercomputer, mobile device tablet, phone, smartphone, mainframe computer system, handheld computer, workstation, network computer, a consumer device, server, file server, application server, storage server, web server, cloud computing server, or in general any type of computing system or device. It is noted that the number of components of system 100 can vary from embodiment to embodiment. There can be more or fewer of each component/subcomponent than the number shown in FIG. 1. It is also noted that system 100 can include other components not shown in FIG. 1. Additionally, in other embodiments, system 100 can be structured in other ways than shown in FIG. 1.

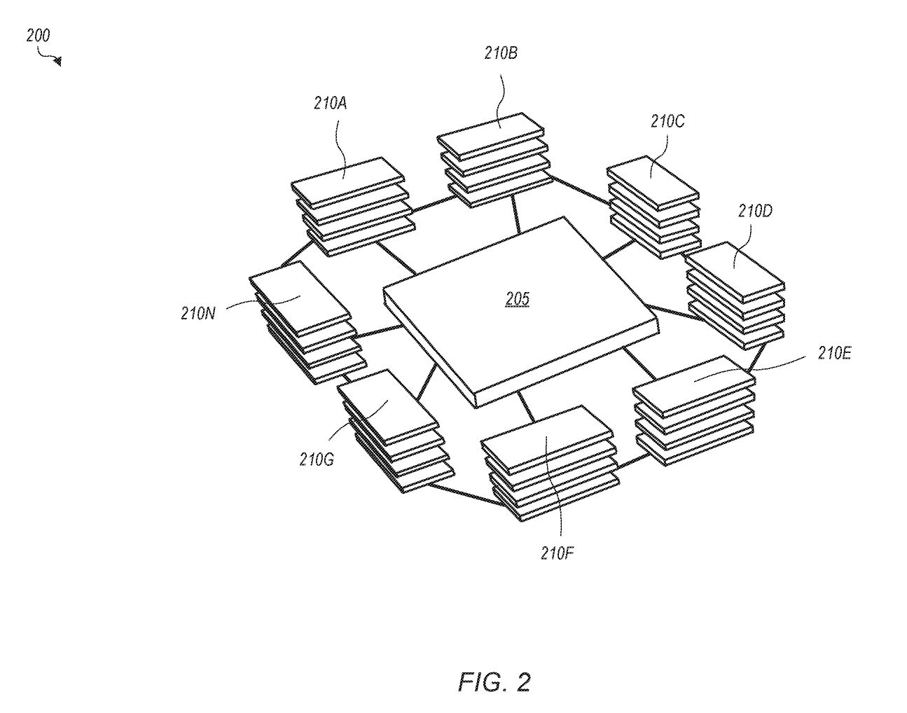

Turning now to FIG. 2, a block diagram of another embodiment of a computing system 200 is shown. Computing system 200 is another example of a system which can implement the techniques described herein for improving data locality for distributed processing units. As shown in FIG. 2, system 200 includes a plurality of compute stacks 210A-N coupled to a command processor 205. Compute stacks 210A-N are representative of any number and type of compute stacks.

In one embodiment, each compute stack 210A-N includes a logic layer and multiple memory layers. In one embodiment, the memory layers of compute stacks 210A-N are implemented as die-stacked dynamic random-access memory (DRAM). In one embodiment, each compute stack 210A-N includes one or more memory devices coupled to a processing in memory (PIM) device integrated directly with the memory device(s). A PIM architecture is a concept of adding computational capabilities in or near memory. The benefits of this architecture include reduced latency and energy consumption associated with data movement between the processing device and the memory hierarchy. For example, the computation capabilities of each compute stack 210A-N can be implemented on a separate logic die which is vertically stacked with the memory dies. Additionally, the methods and mechanisms described herein are also applicable to cases where the near memory computation capabilities are implemented directly on the memory dies.

In one embodiment, each compute stack 210A-N is a three dimensional integrated circuit (3D IC) that includes a processing unit on a logic chip which is 3D-stacked with one or more memory chips. In some cases, the processing unit integrated with the memory chips is a fully-programmable processor. The memory die can include stacked memory devices implementing memory circuitry, such as DRAM, static random-access memory (SRAM), read-only memory (ROM), and the like. The logic die can implement hard-wired logic and routing logic for accessing the memory circuitry of the stacked memory die. Each memory module can be fabricated using any of a variety of 3D integrated circuit fabrication processes. In one embodiment, the logic die and the memory die can be implemented as separate substrates (e.g., bulk silicon) with active devices and one or more metal routing layers formed at an active surface, and are then stacked together. This approach can include a wafer-on-wafer process whereby a wafer comprising a matrix of die is fabricated and thinned, and through-silicon vias (TSVs) are etched through the bulk silicon. Multiple wafers are then stacked to achieve the illustrated layer configuration (e.g., a stack of three wafers comprising memory circuitry die for three memory layers and a wafer comprising the logic die for the processor layer), aligned, and then joined via thermocompression. The resulting stacked wafer set is singulated to separate the individual 3D IC device. In other embodiments, other techniques for fabricating compute stacks 210A-N can be utilized. In still other embodiments, processing units may be coupled to one or more local memory devices in a non-stacked configuration. These and other embodiments are possible and are contemplated.

Command processor 205 is coupled to compute stacks 210A-N using any of various types of interconnect protocols. Additionally, compute stacks 210A-N can be coupled to each other using any of various types of interconnect protocols. In one embodiment, command processor 205 is configured to partition a workload into a plurality of workgroups, dispatch the workgroups to the distributed compute stacks 210A-N, partition data buffers into a plurality of data partitions, and map the data partitions to the distributed compute stacks 210A-N. In another embodiment, one or more of the compute stacks 210A-N can be configured to execute the code or include the logic of command processor 205 for performing these functions.

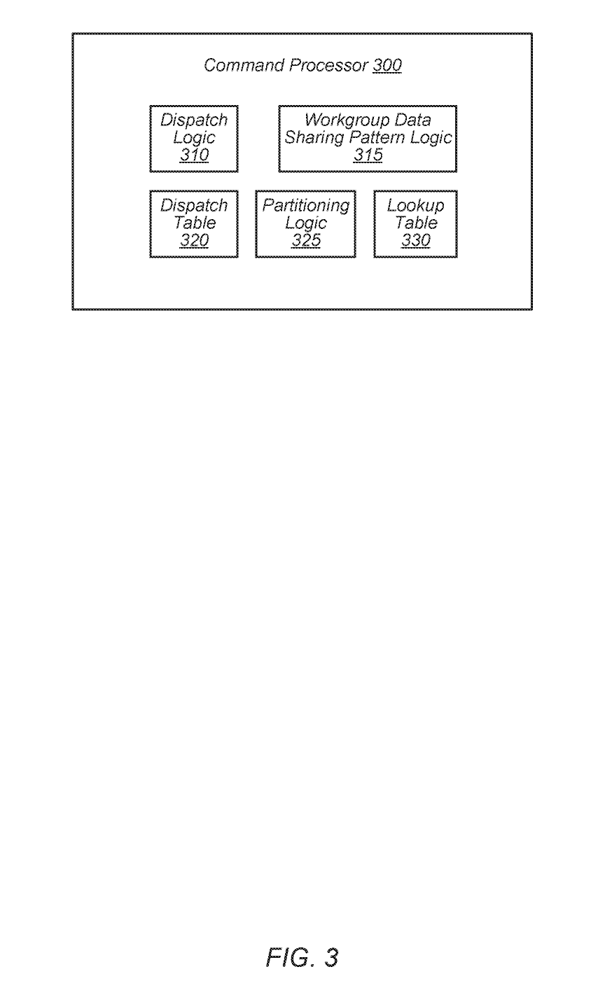

Referring now to FIG. 3, a block diagram of one embodiment of a command processor 300 is shown. In one embodiment, command processor 300 includes dispatch logic 310, workgroup data sharing pattern logic 315, dispatch table 320, partitioning logic 325, and lookup table 330. It is noted that dispatch logic 310, workgroup data sharing pattern logic 315, and partitioning logic 325 can be implemented using any combination of hardware and/or software. It is also noted that in other embodiments, two or more of the logic units shown in command processor 300 can be combined together into a single unit. In one embodiment, the logic shown within command processor 300 can be included within command processor 205 of FIG. 2. In another embodiment, the logic shown within command processor 300 can be included within CPU 130 of FIG. 1.

In one embodiment, partitioning logic 325 is configured to partition a workload into a plurality of workgroups. In one embodiment, dispatch logic 310 is configured to dispatch workgroups to the various distributed processing units (not shown) of the system (e.g., system 100 (of FIG. 1), system 200 (of FIG. 2)). In one embodiment, the distributed processing units are GPUs. In another embodiment, the distributed processing units are PIMs. In other embodiments, the distributed processing units can be other types of processing units. Once workgroup partitioning has been determined, dispatch table 320 is updated. In one embodiment, dispatch table 320 is implemented as a bit vector to specify which workgroup ID maps to which processing unit on a kernel basis. If a data-independent workgroup partitioning scheme is used to dispatch workgroups to processing units, a mathematical function (e.g., floor(workgroup_ID/N) mod (number_of_processing_units) for dispatching N consecutive workgroups to each processing unit) can be used instead of dispatch table 320.

In one embodiment, workgroup data sharing pattern logic 315 is configured to determine how the various workgroups of a given kernel access and share the data buffers processed by the given kernel. In one embodiment, workgroup data sharing pattern logic 315 analyzes the addresses and data accessed by each workgroup to identify sets of workgroups that access a threshold amount of shared data. In another embodiment, workgroup data sharing pattern logic 315 identifies sets of workgroups that access the same data partitions even if these sets of workgroups do not actually share the same data. For example, a first workgroup might access a first portion of data within a first data partition and a second workgroup might access a second portion of data within the first data partition, with the first portion and second portion not overlapping. However, if the first workgroup and second workgroup are grouped together and dispatched to the processing unit which stores the first data partition, this will result in a high number of local memory accesses being performed for the first workgroup and second workgroup. After performing the analysis, workgroup data sharing pattern logic 315 conveys indications of which workgroups should be grouped together to dispatch logic 310.

Dispatch logic 310 can then dispatch workgroups to the same processing unit when the workgroups access a threshold amount of shared data or access different data but within the same data partition.

In one embodiment, partitioning logic 325 is configured to partition data buffers into partitions that can be mapped to different processing units of the distributed processing units. Partitioning logic 325 can determine how the data buffers are accessed and shared by the various workgroups and then partitioning logic 325 can partition the data buffers based on the data sharing, data access, and data locality patterns of the workgroups. If multiple kernels access the same data buffers, then one kernel's access pattern can be used to determine data partitioning. The kernel which is used can be chosen randomly, chosen based on the execution time, chosen based on the ease of determining data-access patterns, or other criteria. Partitioning logic 325 is also configured to map portions of the data buffers to the different processing units so as to maximize local memory accesses and minimize remote memory accesses.

In one embodiment, data mapping information is maintained in lookup table 330. In one embodiment, the data mapping information in lookup table 330 is updated by the operating system (OS) when new physical addresses are allocated and mapped to a specific processing unit's memory. Lookup table 330 can be a centralized table or each processing unit can maintain a local copy of lookup table 330. In one embodiment, a number of bits of a physical address are used to index into lookup table 330. The actual number of bits that are used can vary from embodiment to embodiment. The specific bits used can also vary from embodiment to embodiment and can depend on the data-partitioning granularity, such as cache lines, page size, multiple pages, etc. If a table access is a miss (i.e., the item being looked up does not exist in the table), a default address mapping can be used. A hit (i.e., the item being looked up does exist in the table) indicates that the address belongs to a data buffer that is accessed by a kernel and its partitioning and mapping to processing units is known to the lookup table 330. The mapping information stored in the table entry can be used to find the data location. Each entry in lookup table 330 can include a GPU ID, a memory ID, or a mathematical function based on the address to compute the mapped GPU ID or memory ID.

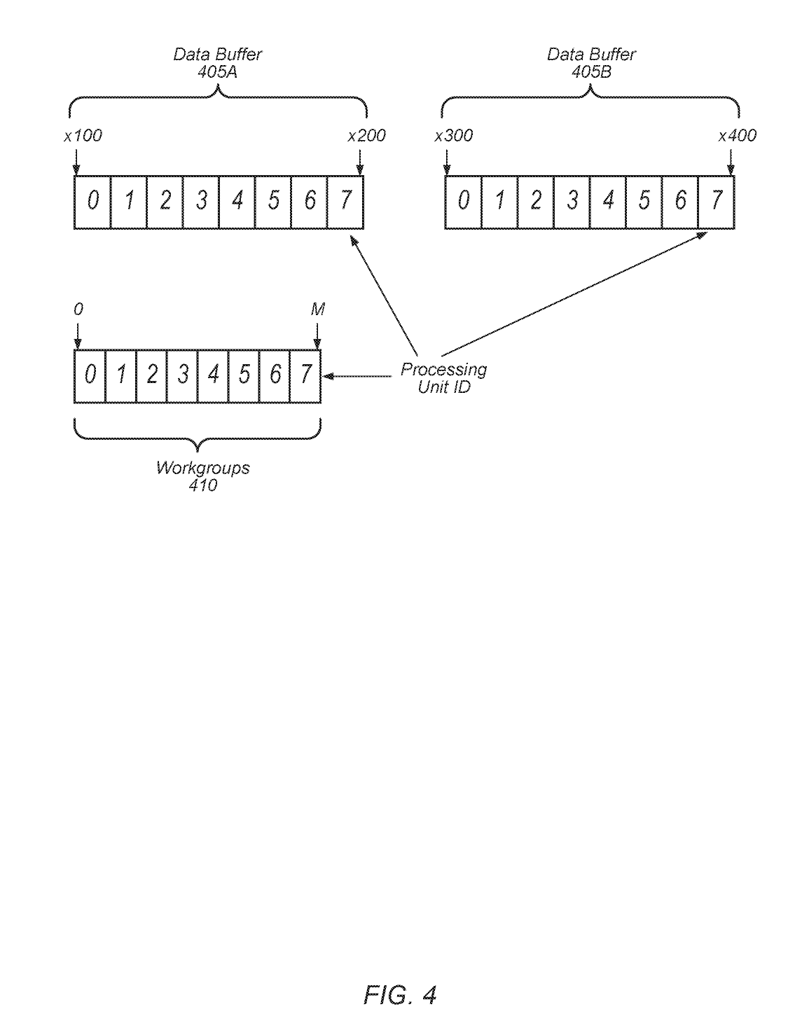

Turning now to FIG. 4, diagrams of one embodiment of data buffer and workgroup partitioning are shown. A system (e.g., system 100 (of FIG. 1), system 200 (of FIG. 2)) can include a plurality of distributed processing units with corresponding local memory devices. In one embodiment, the distributed processing units can be treated as a single logical processing unit. In the example illustrated in FIG. 4, it is assumed that the system has 8 distributed processing units. It should be understood that this is indicative of one embodiment. In other embodiments, the system can have other numbers of distributed processing units.

The system can execute a kernel which operates on one or more data buffers 405A-B. Data buffers 405A-B are examples of data buffers which are partitioned and mapped to the different processing units. As shown in FIG. 4, data buffers 405A-B are partitioned into eight partitions assuming the system has 8 distributed processing units. In other embodiments, data buffers 405A-B can be partitioned into other numbers of buffer partitions depending on the number of distributed processing units in the system. Additionally, in other embodiments, other numbers of data buffers can be partitioned.

Workgroups 410 are representative of any number and type of workgroups. Generally speaking, data buffers 405A-B and workgroups 410 can have M partitions, wherein M is a positive integer. In one embodiment, M is equal to the total number of workgroups divided by a number of processing units. The system partitions the processing workload into subsets of workgroups 410 which can be assigned to different processing units. The system also partitions data buffers 405A-B into portions of data which can be mapped to the local memory of the different processing units. As shown in FIG. 4, the number shown within a partition of data buffers 405A-B and workgroups 410 corresponds to the destination processing unit ID. The system performs the partitioning and mapping in a manner which attempts to minimize the number of remote memory accesses and maximize the number of local memory accesses for the workgroups executing on the different distributed processing units.

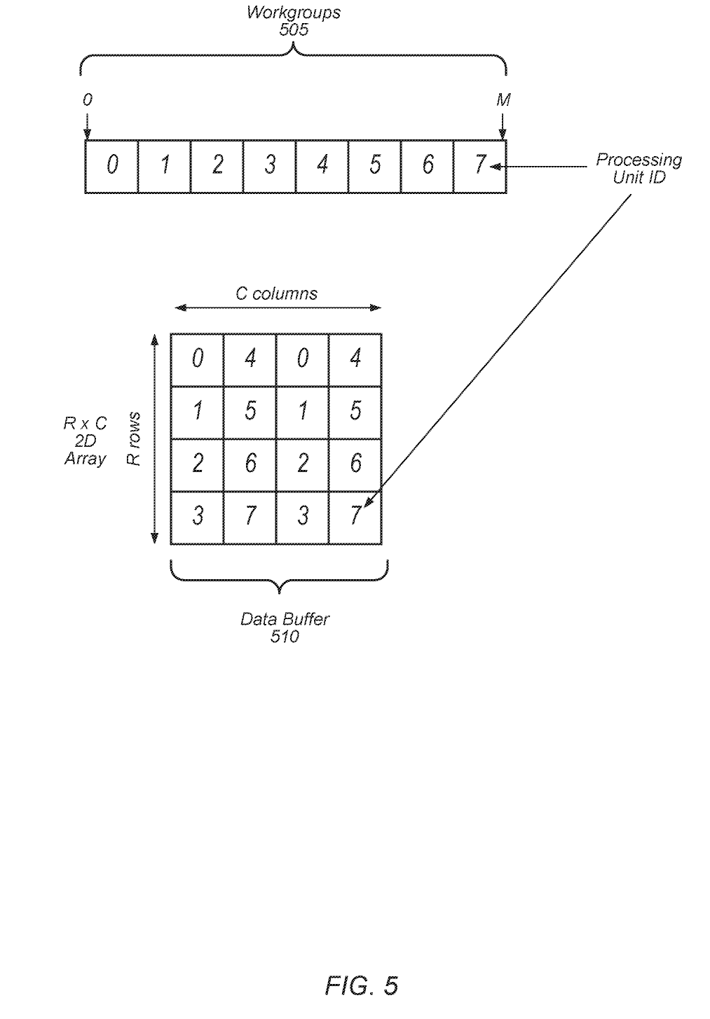

Referring now to FIG. 5, diagrams of another embodiment of workgroup partitioning and data buffer partitioning are shown. In one embodiment, a system can determine how to partition data buffer 510 based on how workgroups 505 access and share the data in data buffer 510. Based on analyzed data access and data sharing patterns of data buffer 510, data buffer 510 can be partitioned and mapped to memory devices in a manner such that workgroups perform an increased number of local memory accesses as compared to non-local memory accesses. In the example shown in FIG. 5, data buffer 510 is a two-dimensional (2D) array.

Consider a case where workgroups 505 access data buffer 510 in a manner where each partition of workgroups accesses a rectangular region of the data buffer, and subsequent partitions of workgroups access different such rectangular regions, traversing the buffer in column-major order. The access pattern repeats after a rectangular region has been assigned to be accessed by each of the workgroup partitions, with the first partition of workgroups accessing the next-available rectangular area of the data buffer. In this case, if data buffer 510 is laid out in a row-major manner in memory, the approach of creating M contiguous partitions for both data buffer 510 and workgroups 505 would result in misalignment between data buffer 510 and workgroups 505. One way to mitigate this misalignment is to create finer-grained partitions along the columns of data buffer 510 while keeping the same workgroup 505 partitioning. Depending on the embodiment, the partitioning can be performed at the cache-line or OS-page granularity or by using a larger region. Accordingly, there can be more than M data partitions for M

workgroup partitions. In other words, the data buffer 510 can be partitioned at a finer granularity than the workgroups 505.

As shown in FIG. 5, the size of each data partition of data buffer 510 is R/4 rows by C/4 columns. There are a total of 16 data partitions for data buffer 510 for the 8 workgroup partitions for 8 processing units. Each number 0-7 in data buffer 510 indicates that the data partition is accessed by the workgroups mapped to the processing unit corresponding to the same number 0-7. It is noted that the example of partitioning data buffer 510 into partitions with a size of R/4 rows by C/4 columns is merely one example of partitioning that can be performed. It should be understood that other partitioning schemes can be utilized in other embodiments.

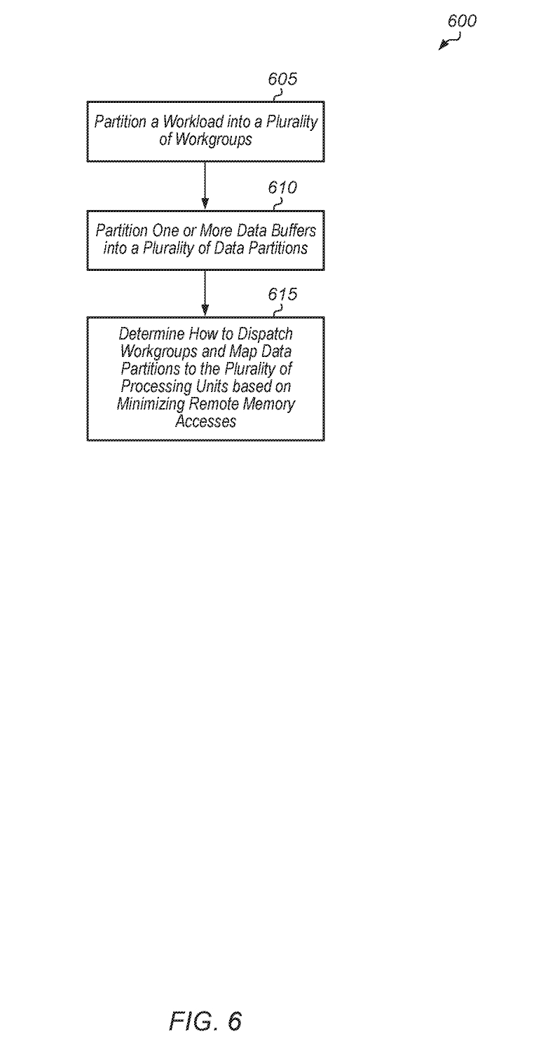

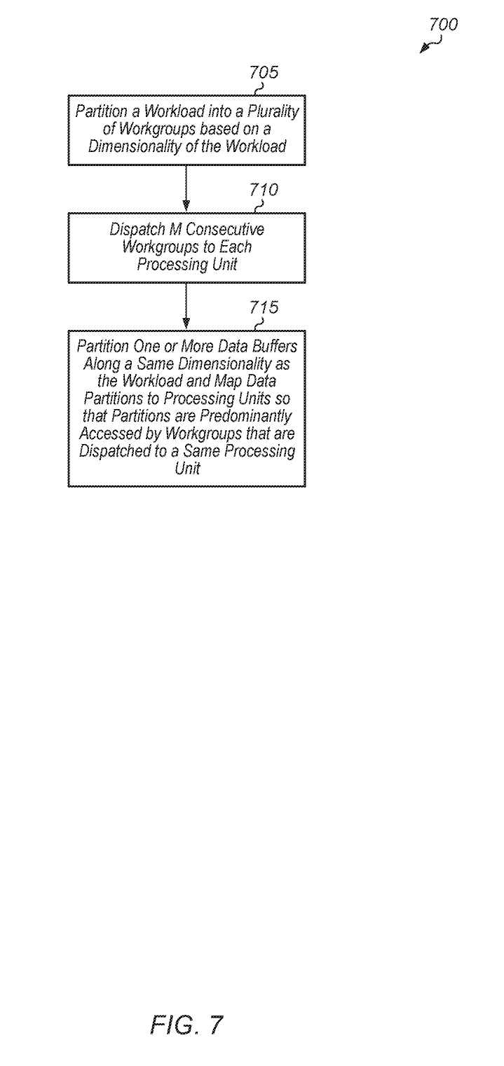

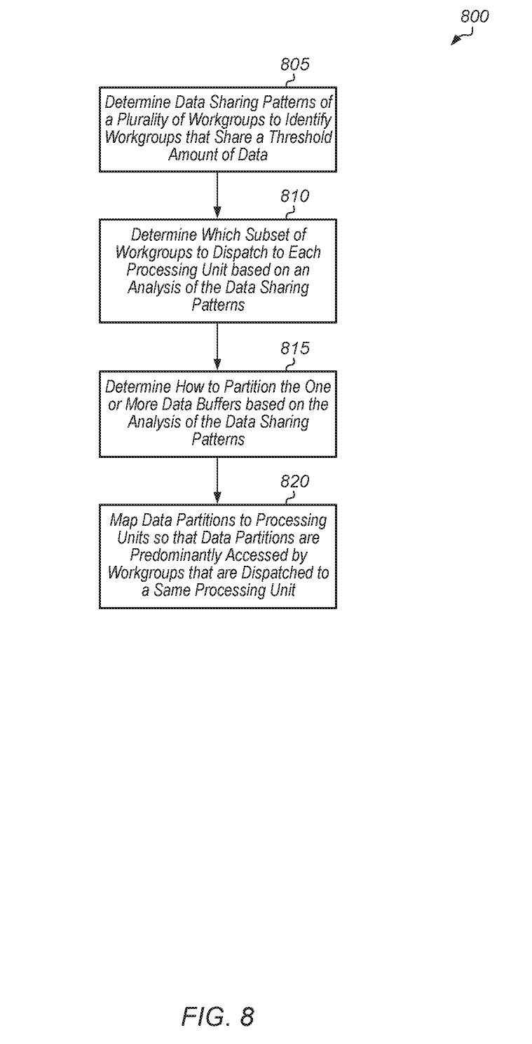

Turning now to FIG. 6, one embodiment of a method 600 for partitioning a workload and data buffers is shown. For purposes of discussion, the steps in this embodiment and those of FIGS. 7-8 are shown in sequential order. However, it is noted that in various embodiments of the described methods, one or more of the elements described are performed concurrently, in a different order than shown, or are omitted entirely. Other additional elements are also performed as desired. Any of the various systems or apparatuses described herein are configured to implement method 600.

A system partitions a workload into a plurality of workgroups (block 605). The system includes a plurality of processing units and a plurality of memory devices. In one embodiment, each processing unit of the plurality of processing units is coupled to one or more local memory devices of the plurality of memory devices. In one embodiment, each processing unit is a GPU. In another embodiment, each processing unit is a PIM device. In other embodiments, the processing units can be other types of devices.

Next, the system and partitions one or more data buffers into a plurality of data partitions (block 610). Then, the system determines how to dispatch workgroups to the plurality of processing units and map data partitions to the plurality of memory devices based on minimizing accesses to non-local memory devices (block 615). In the above context, the term “minimizing” can be defined as reducing the number of remote memory accesses that are generated by the processing units as compared to a standard dispatching and mapping scheme that does not take into account the dimensionality of the workload (described in method 700 of FIG. 7) nor the data sharing patterns of the workgroups (described in method 800 of FIG. 8). After block 615, method 600 ends.

Referring now to FIG. 7, another embodiment of a method 700 for partitioning a workload and data buffers is shown. In the example shown, a system partitions a workload into a plurality of workgroups based on a dimensionality of the workload (block 705). The system includes a plurality of processing units and a plurality of memory devices. In one embodiment, each processing unit of the plurality of processing units is coupled to one or more local memory devices of the plurality of memory devices.

The system dispatches M consecutive workgroups to each processing unit, wherein M is a positive integer (block 710). In one embodiment, M is equal to the total number of workgroups divided by a number of processing units in the system. Also, the system partitions one or more data buffers along a same dimensionality as the workload and maps data partitions to memory devices in a manner such that workgroups perform an increased number of local memory accesses as compared to non-local memory accesses (block 715). In one embodiment, the one or more data buffers are partitioned at a finer granularity than the workload. After block 715, method 700 ends.

Turning now to FIG. 8, one embodiment of a method 800 for partitioning a workload into subsets of workgroups that share a threshold amount of data is shown. In the example shown, a system determines the data sharing patterns of a plurality of workgroups to identify workgroups that share a threshold amount of data (block 805). In one embodiment, the data sharing patterns are determined at compile-time by a compiler. In another embodiment, the data sharing patterns are determined at run-time by control logic and/or software. In yet another embodiment, the data sharing patterns are determined by profiling the application in hardware and/or software. In some embodiments, the system can also determine the data access patterns and/or data locality patterns of the plurality of workgroups. Next, the system determines which subset of workgroups to dispatch to each processing unit based on an analysis of the data sharing patterns (block 810). Then, the system determines how to partition one or more data buffers based on the analysis of the data sharing patterns (block 815). Next, the system maps data partitions to memory devices in a manner such that workgroups perform an increased number of local memory accesses as compared to non-local memory accesses (block 820). It is noted the system can also utilize the data access patterns and/or data locality patterns when performing blocks 810, 815, and 820. After block 820, method 800 ends.

In various embodiments, program instructions of a software application are used to implement the methods and/or mechanisms previously described. The program instructions describe the behavior of hardware in a high-level programming language, such as C. Alternatively, a hardware design language (HDL) is used, such as Verilog. The program instructions are stored on a non-transitory computer readable storage medium. Numerous types of storage media are available. The storage medium is accessible by a computing system during use to provide the program instructions and accompanying data to the computing system for program execution. The computing system includes at least one or more memories and one or more processors configured to execute program instructions.

It should be emphasized that the above-described embodiments are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
a plurality of memory devices; and
a plurality of processing units, wherein each processing unit of the plurality of processing units is coupled to one or more local memory devices of the plurality of memory devices;
wherein the system is configured to:
partition a workload into a plurality of workgroups;
partition one or more data buffers into a plurality of data partitions; and
determine how to dispatch workgroups to the plurality of processing units and map data partitions to the plurality of memory devices based on minimizing accesses to non-local memory devices.

2. The system as recited in claim 1, wherein the system is further configured to:
partition the workload into a plurality of workgroups based on a dimensionality of the workload; and
dispatch M consecutive workgroups to each processing unit, wherein M is equal to a total number of workgroups divided by a number of processing units.

3. The system as recited in claim 2, wherein the system is further configured to partition the one or more data buffers along a same dimensionality as the workload and map data partitions to memory devices in a manner such that workgroups perform an increased number of local memory accesses as compared to non-local memory accesses.

4. The system as recited in claim 3, wherein the one or more data buffers are partitioned at a finer granularity than the workload.

5. The system as recited in claim 1, wherein the system is further configured to:
determine data sharing patterns of the plurality of workgroups to identify workgroups that share a threshold amount of data;
determine which subset of the plurality of workgroups to dispatch to each processing unit of the plurality of processing units based on an analysis of the data sharing patterns;
determine how to partition the one or more data buffers based on the data sharing patterns of the plurality of workgroups; and
map partitions to memory devices in a manner such that workgroups perform an increased number of local memory accesses as compared to non-local memory accesses.

6. The system as recited in claim 1, wherein the system comprises a dispatch table to specify which workgroup identifier (ID) maps to which processing unit on a kernel basis.

7. The system as recited in claim 1, wherein the system is configured to:
identify two or more workgroups that share a threshold amount of data; and
dispatch the two or more workgroups to a first processing unit.

8. A method comprising:
partitioning a workload into a plurality of workgroups;
partitioning one or more data buffers into a plurality of data partitions; and
determining how to dispatch workgroups to a plurality of processing units and map data partitions to the local memory devices of the plurality of processing units based on minimizing non-local memory accesses.

9. The method as recited in claim 8, further comprising:
partitioning the workload into a plurality of workgroups based on a dimensionality of the workload; and
dispatching M consecutive workgroups to each processing unit, wherein M is equal to a total number of workgroups divided by a number of processing units.

10. The method as recited in claim 9, further comprising partitioning the one or more data buffers along a same dimensionality as the workload and mapping data partitions to memory devices in a manner such that workgroups perform an increased number of local memory accesses as compared to non-local memory accesses.

11. The method as recited in claim 10, further comprising partitioning the one or more data buffers at a finer granularity than the workload.

12. The method as recited in claim 8, further comprising:
determining data sharing patterns of the plurality of workgroups to identify workgroups that share a threshold amount of data;
determining which subset of the plurality of workgroups to dispatch to each processing unit of the plurality of processing units based on an analysis of the data sharing patterns;
determining how to partition the one or more data buffers based on the data sharing patterns of the plurality of workgroups; and
mapping partitions to memory devices in a manner such that workgroups perform an increased number of local memory accesses as compared to non-local memory accesses.

13. The method as recited in claim 8, further comprising utilizing a dispatch table to specify which workgroup identifier (ID) maps to which processing unit on a kernel basis.

14. The method as recited in claim 8, further comprising:
identifying two or more workgroups that share a threshold amount of data; and
dispatching the two or more workgroups to a first processing unit.

15. A non-transitory computer readable storage medium storing program instructions, wherein the program instructions are executable by a processor to:
partition a workload into a plurality of workgroups;
partition one or more data buffers into a plurality of data partitions; and
determine how to dispatch workgroups to a plurality of processing units and map data partitions to the local memory devices of the plurality of processing units based on minimizing non-local memory accesses.

16. The non-transitory computer readable storage medium as recited in claim 15, wherein the program instructions are further executable by a processor to:
partition the workload into a plurality of workgroups based on a dimensionality of the workload; and
dispatch M consecutive workgroups to each processing unit, wherein M is equal to a total number of workgroups divided by a number of processing units.

17. The non-transitory computer readable storage medium as recited in claim 16, wherein the program instructions are further executable by a processor to partition the one or more data buffers along a same dimensionality as the workload and map data partitions to memory devices in a manner such that workgroups perform an increased number of local memory accesses as compared to non-local memory accesses.

18. The non-transitory computer readable storage medium as recited in claim 15, wherein the program instructions are further executable by a processor to partition the one or more data buffers at a finer granularity than the workload.

19. The non-transitory computer readable storage medium as recited in claim 15, wherein the program instructions are further executable by a processor to:
determine data sharing patterns of the plurality of workgroups to identify workgroups that share a threshold amount of data;
determine which subset of the plurality of workgroups to dispatch to each processing unit of the plurality of processing units based on an analysis of the data sharing patterns;
determine how to partition the one or more data buffers based on the data sharing patterns of the plurality of workgroups; and
map partitions to memory devices in a manner such that workgroups perform an increased number of local memory accesses as compared to non-local memory accesses.

20. The non-transitory computer readable storage medium as recited in claim 15, wherein the program instructions are further executable by a processor to:
identify two or more workgroups that share a threshold amount of data; and
dispatch the two or more workgroups to a first processing unit.
